(19) United States
(12) Patent Application Publication
(10) Pub. No.: US 2012/0290480 A1
(43) Pub. Date: Nov. 15, 2012

(54) ELECTRONIC PAYMENT USING TRANSACTION IDENTITY CODES

(76) Inventor: Bilin Chen, Cupertino, CA (US)

(21) Appl. No.: 13/466,694

(22) Filed: May 8, 2012

Related U.S. Application Data
(60) Provisional application No. 61/483,746, filed on May 9, 2011.

(51) Int. Cl. G06Q 20/40

(52) U.S. Cl. 705/44

(57) ABSTRACT

A method for making payments utilizes a server that has a unified transaction identification system. Upon receiving an offer of a transaction from a payee, the server generates a unique transaction identity on behalf of the payee, encodes the unique transaction identity into an encoded image, and sends the image to a transaction initiating terminal to be displayed to a payer. The payer uses a mobile device to scan the displayed encoded image, repackages the transaction identity and the buyer's payment method information into an acceptance, and sends the acceptance to the server, which identifies the transaction according to the unique transaction identity, and allows a payment to be made according to the identified transaction from a payer financial account to a payee financial account.

### RELATED APPLICATIONS

This application claims priority from U.S. provisional patent application, Application No. 61/483746, filed May 9, 2011, entitled “ELECTRONIC PAYMENT SYSTEM AND METHOD USING IMAGE RECOGNITION TECHNIQUE”.

### BACKGROUND

The present disclosure relates to the field of payments, and particularly relates to methods and systems of electronic payments using a mobile device.

A variety of electronic payment methods and systems exist, with a rapidly increasing mobile payment trend. One approach to mobile payment is to use the NFC function of a mobile phone as a substitute of the swiping function of a credit card, while retaining the traditional backend payment systems including credit card companies, credit card processors, and banks. Both Google Wallet and Isis payment system belong to this type. Another approach to mobile payment is to use an intermediary account. An application program runs on both a mobile device of the payer and a client device of the payee to securely connect the payer's device and the payee's device to the intermediary account, which manages one or more credit card or a bank account of the user. PayPal's mobile payment solution belongs to this type.

The issues faced by mobile payment are multifaceted, including security, privacy, efficiency, convenience, integrity of the process, and account management. Although some existing methods improve certain aspects of the mobile payment process, they fall short on other aspects. There is a need for a payment method and system that further improve the payment process, especially convenience and privacy.

### SUMMARY OF THE DISCLOSURE

Disclosed are a method and a system for making an electronic payment using a mobile device. The payment method utilizes a server that has a unified transaction identification system. Upon receiving an offer of a transaction from a payee, the server generates a unique transaction identity on behalf of the payee, encodes the unique transaction identity into an encoded image such as a 2-D barcode, and sends the encoded image to a transaction initiating terminal to be displayed to a payer. The payer uses a mobile device to scan the encoded image, repackages the transaction identity and the buyer's payment method information into an acceptance, and sends the acceptance to the server, which identifies the transaction, and allows a payment to be made according to the identified transaction from a payer financial account to a payee financial account.

The transaction identities are created and managed by the payment system at the server side. This enables the method and the system to handle multiple payees with unique transaction identities across the system.

In addition to the unique transaction identity, the payment system may receive and retain a sufficient amount of information related to each transaction to facilitate the completion of the payment transaction and post-payment transaction management. Such information may include a description of the type of the transaction, the product or service being purchased, the amount of money involved, effective date of an offer, and the payee's identity.

The payer has an option to install an application program on his mobile device, such that the encoded image may be scanned directly into the application program and sent to the server through the application program. In some embodiments, the payee may also install an application program on the transaction initiating terminal to enter the offer of the transaction and to display the encoded image received from the server.

The method and the system have a variety of applications, including TV shopping, online shopping, bill payment, payment upon delivery, money transfer, etc.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF DRAWINGS

The detailed description is described with reference to the accompanying figures. In the figures, the left-most digit(s) of a reference number identifies the figure in which the reference number first appears.

FIG. 1 is a diagram of functional blocks of an exemplary environment in which the disclosed system and the method are applied for performing payment transactions.

FIG. 2 is an integrated block flowchart illustrating the payment process in accordance with the present disclosure.

FIG. 3 is a diagram showing functional blocks of an exemplary payer application program installed and run on a payer mobile device.

### DETAILED DESCRIPTION

The method and the system for performing electronic payments is described in further detail using exemplary embodiments accompanying figures.

In this description, the order in which a process is described is not intended to be construed as a limitation, and any number of the described process blocks may be combined in any order to implement the method, or an alternate method.

In this description, the words “merchant”, “seller” and “payee” carry a broad meaning to refer to any business, organization or individual that sells or provides a product or service to a customer, or any business, organization or individual that receives a payment from another for any reason. The word “consumer”, “buyer” and “payer” broadly refers to any individual, business or organization which buys or accesses a product or service, or any business, organization or individual that makes a payment to another for any reason.

The system disclosed herein is used for implementing the method for performing a payment transaction. The system may be a part of an application environment or ecosystem and be designed to perform its intended functions by communicating and interacting with other units and components thereof. The operation of the system is made possible by integrating hardware, software and electronic communications. Herein, a “unit”, “module”, or “component” is a device, tool, machine or a software program designed to perform a particular task or function. A unit, the module or the component can be a piece of hardware, software, a plan or scheme, or a combination thereof, for effectuating a purpose associated with the particular task or function.

In the present disclosure, the information initially provided by a payee is characterized as an “offer”, while the information subsequently submitted by the payer is characterized as an “acceptance”. The words “offer” and “acceptance” are used in a broad sense and are not limited in a narrow sense to “an offer to sell” and “an acceptance to buy”. Depending on the nature of the transaction, an offer may be an equivalent of a request, such as a request to pay. Furthermore, the words “offer” and “acceptance” do not necessarily suggest a legally binding offer and acceptance of two contracting parties. In one embodiment, however, the payment system may indeed impose such business and/or legal terms to bind participants (both payees and payers) with regard to the offer made by the payee and the acceptance made by the payer in each transaction.

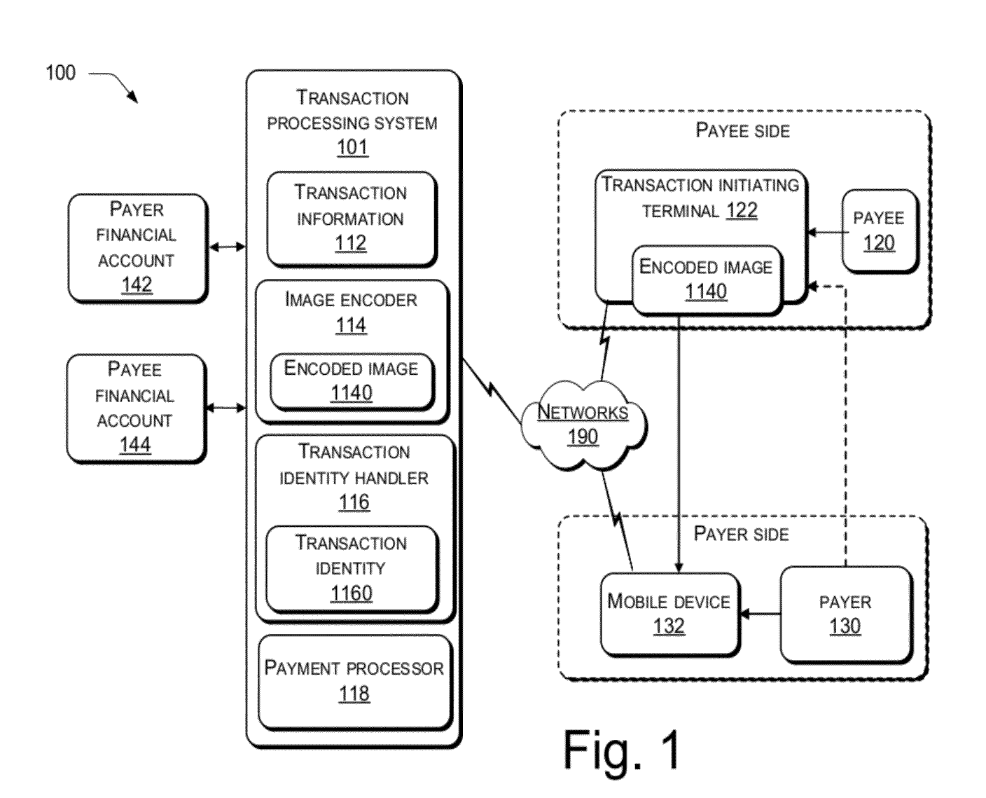

FIG. 1 shows a diagram of functional blocks of an exemplary environment in which the system and the method for performing payment transactions are applied. The environment 100 shows both a server side and a client side. On the server side is the transaction processing system 101 which may include one or more server computers or server clusters located in a single or multiple locations. The transaction processing system 101 has processors and data storages which are commonly used in the server computers and not shown. The transaction processing system 101 is programmed and configured to have several functional units including transaction information unit 112 which stores and processes information related to payment transactions, image encoder 114 which encodes information into an image; transaction identity handler 116 which generates and manages transaction identities 117, and payment processor 118 which performs authorized payments according to the identified payment transactions.

Payee 120 is related to a transaction initiating terminal 122 which can be a computer with a display screen and/or printer, a TV connected to the internet, or a mobile device with a display screen. It is noted that in this description the transaction initiating terminal 122 is described as being on the payer side. This is to illustrate that the transaction initiating terminal 122 is used to display information, collect information and present a user interface on behalf of payee 120. This does not suggest that the transaction initiating terminal 122 must be physically owned by payee 120 or physically located on premises of payee 120. In some applications, for example, the transaction initiating terminal 120, such as a computer or TV may be in physical control of payer 130.

Payer 130 uses a mobile device 132 which can be a smart phone with a video camera, or a non-phone mobile device, such as a tablet and an iPod with a video camera.

In one embodiment, payee 120 sends transaction information to transaction processing system 101 through networks 190 which may include the Internet. The transaction information may include necessary information for one or more transactions. Each transaction has information including an offer of a respective transaction. The offer of the transaction includes the type of the transaction, the product or service rendered for sale, the amount of money involved in the transaction. The types of transactions may include a payment for a purchase, paying a bill, paying back the money owed, or transferring money, etc. Transaction processing system 101 receives the transaction information from payee 120 and saves it in transaction information 112.

Payee 120 is not required to have a pre-registered account in transaction processing system 101, although having such a preregistered account may further improve information management in the transaction processing.

The transaction processing system 101 generates a transaction identity 1160 to identify the transaction which is defined by the offer received from payee 120. The transaction identity 1160 preferably has a sufficient level of uniqueness to avoid confusion in the system. In one embodiment, the transaction identity 1160 is unique systemwide among all transactions. In another embodiment, the transaction processing system handles multiple payees, and each transaction identity 1160 generated is unique systemwide with transactions involving any payee using the transaction processing system.

An example of a transaction identity 1160 is an alphanumerical string which can be either schematically or randomly generated by the transaction identity handler 116 and assigned to the current transaction.

The image encoder 114 of transaction processing system 101 then generates an encoded image to encode at least the transaction identity 117. The encoded image can be a graphic pattern such as a barcode that can be scanned into a mobile device by an image recognition technique. The image recognition of the graphic pattern may be performed using a video camera on the mobile device and software installed thereon. In addition to the common 1D barcodes, more sophisticated graphic patterns, such as 2D barcodes (e.g., QR codes, Microsoft tags) and other digitally decodable images may be used.

When the transaction identity 1160 is unique systemwide, it alone enables the transaction processing system 101 to precisely recognize the transaction as defined by the transaction information sent from payee 120. When the payment process needs detailed information of the transaction to complete, such information may be retrieved separately from the transaction processing system 101 after the transaction has been identified using the encoded transaction identity 117 according to one embodiment. In such an embodiment, encoding the transaction identity alone is sufficient for the transaction processing system 101 to perform a payment as described herein. In some embodiments, however, further information such as the product description, price, payee identity, and effective date of the offer is also encoded along with the transaction identity in the encoded image 1140 and transmitted together.

The transaction identity handler 116 then transmits the encoded image 1140 to transaction initiating terminal 122, which displays the image on the screen. Alternatively, the payee 120 may print the received encoded image 1140 and presents the printed image to the payer 130. Either way, the system allows the transmitted encoded image 1140 or information encoded therein to be passed from the transaction initiating terminal 122 to mobile device 132 of payer 130. A convenient way to allow this pass is to use the optical scanning ability of mobile device 132 to scan the encoded image 1140. The mobile device 132 may scan the encoded image 1140 directly without decoding it. Alternatively, the mobile device 132 decodes the encoded image 1140 and obtains the decoded information contained in the encoded image 1140.

Upon receiving the order encoded in image 1140, the payer 130 uses the mobile device 132 to send an acceptance to the transaction processing system 101. The acceptance may include at least the payer's payment method information and a copy of the encoded image 1140 or information encoded therein. The payment method information is preferred to be sufficient to authorize a payment to be made from the payer's financial account, which in one embodiment is an external financial account 142 such as a bank account or a credit card account. The external financial account 142 of the payer may or may not be preregistered with the transaction processing system 101. When the external financial account 142 of the payer is not preregistered, the payer may still make a payment as a guest. However, to avoid requiring the payer to enter the payment method information each time when the payer makes a payment, the payer's payment method such as the financial account 142 may be registered at the transaction processing system 101. Alternatively, the payer's payment method information may be stored locally at the payer's mobile device and made accessible by an application program running in connection with the transaction processing system 101 for making payments.

In an alternative embodiment, the payer's financial account 142 may be an internal deposit account registered and held at the transaction processing system 101. The payer may use an external financial account (not shown) to refill the internal deposit account (financial account 142).

The transaction processing system 101 identifies the transaction identity and the payer's payment method from the received acceptance, and makes a payment according to the identified transaction from the payer financial account 142 to a payee financial account 144.

Because the transaction identity uniquely identifies a corresponding transaction as defined by the payee, the payment may be made with clear specificity for the intended transaction.

The received acceptance may be saved in transaction information 112 along with the offer of the transaction to further assist post-payment processing. For example, if the transaction involves online shopping, the transaction information 112 may contain sufficient information not only for completing an online payment, but also necessary shipping information.

In addition to the unique transaction identity, the payment system 101 may receive and retain a sufficient amount of information related to each transaction to facilitate the completion of the payment transaction and post-payment transaction management. Such information may include a description of the type of the transaction, the product or service being purchased, the amount of money (offer price) involved, effective date of the offer, and the payee's identity. In one embodiment, for example, the transaction processing system 101 keeps necessary information for each transaction in transaction information 112 such that the transactions is further accessible by the payee for bookkeeping and accounting purpose. If formatted properly, transaction information saved in this way can serve as invoice or billing records.

The external financial account 144 of the payee may or may not be preregistered with the transaction processing system 101. When the external financial account 144 of the payee is not preregistered, the payee may still receive a payment. However, to avoid requiring the payee to send the financial account information each time when submitting information of a transaction to the transaction processing system 101, in one embodiment the payee's financial account 144 is registered at the transaction processing system 101.

Any mobile device that has wireless Internet connection may be used for this purpose. In a preferred embodiment, a mobile phone is used. The mobile phone may use a variety of wireless communication technologies such as cellular networks 3G, 4G, EDGE, GPRS or CDMA to complete this step. Other mobile electronic devices, such as iPod touch, wireless Internet-enabled tablets and PDA, may also have sufficient capabilities for wireless communication in accordance with the present disclosure.

When needed, the payer's mobile device 132 may be identified by the transaction processing system 101. Examples of a payer's identifiable information include a hardware serial number of the payer's mobile device, a mobile phone number, a GPS location, and the IP address of the payer's mobile device. The hardware serial number of the payer's mobile electronic device is usually stored in a memory (e.g., a ROM) of the mobile device and readable by a program. Alternatively, the payer identity information may be manually entered by the payer.

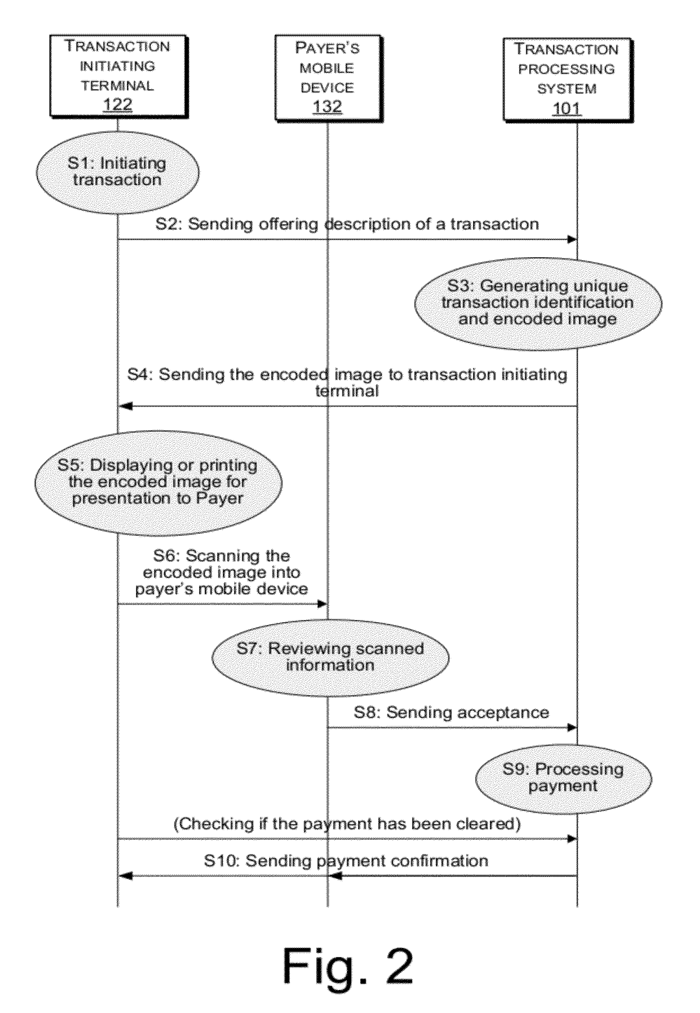

FIG. 2 shows an integrated block flowchart illustrating the payment process in accordance with the present disclosure. This provides an alternative view of the method and the system described with FIG. 1.

In FIG. 2, as in FIG. 1, both payee 120 in connection with transaction initiating terminal 122 and payer 130 with mobile device 132 can exchange information with the transaction processing system 101 on a server side through networks such as the Internet. All three parties can run appropriate software applications in tight integration with the transaction processing system 101. The process of FIG. 2 for making a payment is described as follows.

S1: At the transaction initiating terminal 122, either payee 120 or payer 130 initiates a payment transaction, depending on the transaction type and a design choice of the user interface. This may be part of a shopping and checkout process, or fund transfer process, which includes an option to use the payment method disclosed herein. When payer 130 (e.g., a buyer) is ready to pay, either payee 120 or payer 130 chooses payment method, depending on the user interface of the program running on the transaction initiating terminal 122.

Upon selection of the payment method, payee 120 collects the transaction information, either from the existing information available at the transaction initiating terminal 120 or from an input of payee 120. The transaction information at this point is considered an offer of the transaction which may include a product/merchandise ID, quantity, price, seller's account ID, and/or IP address of the transaction initiating terminal 122.

S2: Payee 120 sends through transaction initiating terminal 122 the collected transaction information to transaction processing system 101, which is hosted at a server.

S3: The transaction processing system 101 processes the transaction information contained in the received offer and generates a unique transaction identification to identify the transaction. The system further generates an encoded image 1140 (such as a graphic pattern) to encode at least the unique transaction identification. The encoded image can be a barcode, especially a QR code, matrix barcode or two-dimensional code, encoding the information using a computer algorithm. The encoded image can be converted back to alphanumeric data by, for example, the payer's mobile device using an application program installed therein.

S4: The system 101 sends the encoded image 1140 to the transaction initiating terminal 122.

S5: The transaction initiating terminal 122 displays the encoded image 1140 on a screen. Alternatively, the encoded image may be printed on a paper. From a business point of view, the encoded image 1140 may be presented to payer 130 as an invoice for a bill.

S6: Payer 130 scans the presented encoded image using a mobile device having an application program installed therein for such a purpose. The scanned encoded image is decoded and converted back to the alphanumeric data at the payer's mobile device using the application program.

S7: Payer 130 reviews the scanned encoded image or the information decoded there from.

S8: Payer 130 agrees to pay (by clicking on a payment button in the application program, for example), and the mobile device 132 sends the acceptance to the transaction processing system 101.

S9: The server processes the payment and makes a money transfer according to the description in the received acceptance. At this junction, the transaction initiating terminal 122 may send a request to check if the payment is cleared.

S10: The transaction processing system 101 sends a payment confirmation to the mobile electronic device 132 of payer 130 and/or the transaction initiating terminal 122.

In one preferred embodiment, the payer's mobile device has a special-purpose application program (an app, such as an iPhone app or Android app) installed that can connect to the transaction processing system 101 and perform payment functions directly. Alternatively, such functions may be performed using a web browser instead of a special-purpose application program. For example, the server can host a website which is visited by the payer's mobile device.

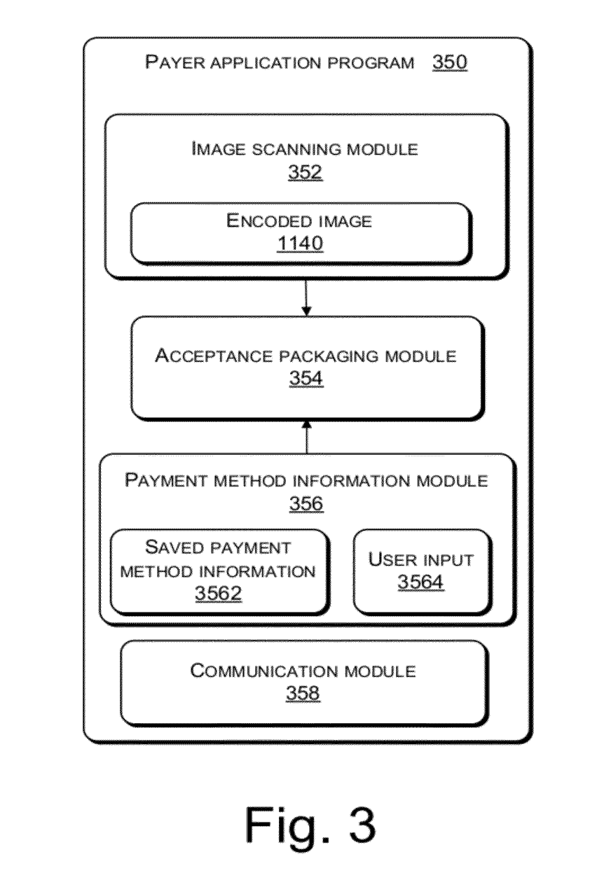

FIG. 3 is a diagram showing functional blocks of an exemplary payer application program installed and run on a payer mobile device. Payer application program 350 is a mobile application program downloadable to the mobile device such as a mobile phone. Once application program 350 is installed, the payer uses the program to make payments. Image scanning module 352 uses a built-in camera of the mobile device to scan the displayed encoded image 1140 into the mobile device. Acceptance packaging module 354 packages the encoded image 1140 or information contained therein and payer's payment method information into an acceptance to be sent to transaction processing system 101.

The payment method information (such as credit card and bank account information) is handled by payment method information module 356, which includes saved payment method information 3562 and user input 3564. Payer may enter the payment method information through user input 3564, either manually or through a data exchange link. In one embodiment, the entered payment method information is saved in saved payment method information 3562, which can be then used by acceptance packaging module 354 when making a payment without requiring the payer to enter such information again. Payer application program 350 may be designed in a way that the saved payment method information 3562 is either automatically provided to acceptance packaging module 354 or provided by a manual selection by the payer.

Communication module 358 communicates the acceptance to the transaction processing system 101.

Exemplary applications of the disclosed method and system represented by a payment method called “Scan to Pay” are further described below.

Online shopping: any online website that sells products and services including hardware products, video entertainment programs, and online game credits, may implement the method and system disclosed herein. In this case, the transaction initiating terminal 122 is a computer or a device with Internet access used by the payer to access the online website for shopping. Payer 130 is a buyer. Payee 120 is an online vendor or retailer. The mobile device 132 may be a mobile phone of by the buyer.

When the buyer is ready to check out, he clicks the “Scan to Pay” button which is listed as an option among available payment methods to initiate a transaction. The payee's online shopping program (a front end of which is presented on the computer used by the buyer to conduct online shopping) creates an offer based on the buyer's selection and sends the offer through the Internet to a server of the transaction processing system. The transaction information sent with the offer may include seller's identity or account, transaction amounts, IP address of the computer.

The server processes the received transaction information, generates and assigns a transaction identity to the transaction, and generates an encoded image to encode the transaction identity and the above transaction information. The server then sends the encoded image back to the computer used for online shopping by the buyer and displayed on the screen of the computer.

The buyer scans the displayed encoded image using a mobile device, which then packages the scanned information together with the buyer's payment account information, and sends the packaged information to the server. The server identifies the ongoing transaction by the unique transaction identity, processes the transaction information, and proceeds to complete the payment by making a money transfer using the payment authorization contained in the information received from the buyer. The server then sends a confirmation of the payment to the computer where the transaction was initiated and/or the buyer's mobile device.

Bill payment: Any business that sends bills to customers may use the disclosed method and system to receive payment from the customers. Examples include restaurant checks (bills) and utility bills, either in paper or electronic form.

For example, the biller sends the billing information to a server of the transaction processing system, which generates an encoded image to encode the payment information and sends the encoded image back to a transaction initiating terminal which may be a computer of the biller. In this case, the transaction is initiated by the biller, and the customer (payer) may not have access to the transaction initiating terminal

The biller then prints the encoded image on a paper bill sent by mail or includes the encoded image in an electronic bill sent in an email. The customer receives the encoded image and scans it into a mobile device, which then packages the scanned information with the customer's payment account information and sends it to the server. The server identifies the transaction, processes the transaction information, and proceeds to complete the bill payment.

Payment on delivery: In this case, the delivery person uses a mobile device (such as a handheld scanner) as a transaction initiating terminal The mobile device has an application program of the disclosed payment method and system installed thereon. The mobile device of the delivery person communicates with the transaction processing system, which generates an encoded image to encode a transaction identity and related delivery information. The delivery person shows the encoded image to the payer who is receiving a package being delivered. The payer's own mobile device scans the encoded image displayed on the delivery person's mobile device, packages the scanned information along with the payer's payment account information, and sends the packaged information to the server. The server identifies the transaction, processes the transaction information, and proceeds to complete the payment.

The server sends a confirmation message to the delivery person's mobile device. In one embodiment, the confirmation message is a new encoded image encoding the updated transaction information including the payment status. The delivery person can use his mobile device to decode the image to check if the payment has been cleared.

Private person-to-person payment: In this case, each of the two parties (payer and payee) uses a respective mobile device. The payee inputs the money collection information and sends a request to pay (an offer) to the transaction processing system. This is preferably done using application program installed on the payee's mobile device. The payee's mobile device receives an encoded image encoding the unique transaction identity and other transaction information from the system. The payee shows the received encoded image to the payer, who scans the encoded image into the payer's mobile device, which packages the scanned information with the payer's payment account information, and sends an acceptance to the server of the system. The server processes the transaction information, and proceeds to complete the money transfer. The server sends a confirmation message to the mobile devices of both parties.

The disclosed method and system for payment protects the payer's personal information, such as name, phone number, email address, credit card numbers and banking account information, from being disclosed to payees. The method allows for complete payer anonymity and improves both security and privacy. For example, when the payer uses the payment method to order a “pay-per-view” or “video-on-demand” program on a TV or computer, the payer can pay for the order securely and privately. The charge will not show on the hotel invoice if the payer placed the order while staying at a hotel.

In one embodiment, the payer can save his payment account information in the payer mobile device, so there is no need to input the payment account information every time when a payment needs to be made during shopping (online and off-line) and other activities.

No physical credit card or bankcard is necessary for the payer or the payee, and no card-reading equipment is needed for the payee. There is further no need for either party's mobile device to have or use NFC functionality or other wireless capabilities such as Bluetooth to exchange information with each other and with the server. Both the offer for an order (e.g., billings or invoices with unique transaction identities) and the acceptance for making a payment are created and managed in the cloud and communicated through the cloud, even though the initiation of the transaction and delivery of the goods (product or service) may happen either online or off-line.

It is noted that the above process is not restricted to the particular order as illustrated. It is further appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method for performing a payment transaction, the method comprising:
receiving at a server an offer of a transaction from a payee, the offer of the transaction including at least a description of the transaction and an amount of money involved in the transaction;
generating in a transaction processing system on the server a transaction identity to identify the transaction, the transaction identity being unique systemwide among all transactions using the transaction processing system;
generating at the server an encoded image encoding at least the transaction identity;
transmitting from the server the encoded image to a transaction initiating terminal;
allowing the encoded image or information encoded therein to be passed from the transaction initiating terminal to a mobile device of a payer;
receiving an acceptance of the offer at the server from the mobile device of the payer, the acceptance including at least the payer's payment method information and a copy of the encoded image or information encoded therein, wherein the payment method information is sufficient to authorize a payment to be made from a payer financial account;
identifying from the acceptance at the server the transaction identity and the payer's payment method; and
making a payment according to the identified transaction from the payer financial account to a payee financial account.

2. The method as recited in claim 1, wherein receiving at the server the offer of the transaction from the payee comprising:
receiving the offer of the transaction from an application program run at the transaction initiating terminal.

3. The method as recited in claim 1, wherein the payer financial account is unregistered and external to the transaction processing system.

4. The method as recited in claim 1, further comprising:
creating at the server a transaction data entry for the transaction for bookkeeping, the transaction data entry being stored at the server and including at least the transaction identity, the description of the transaction, and a payment status.

5. The method as recited in claim 1, wherein allowing the encoded image or information encoded therein to be passed from the transaction initiating terminal to the mobile device of the payer comprises:
displaying the encoded image on the transaction initiating terminal; and
allowing the displayed image to be optically scanned by the mobile device.

6. The method as recited in claim 1, wherein receiving at the server from the mobile device of the payer the acceptance comprises:
receiving the acceptance from an application program run on the mobile device of the payer, the application program being programmed to transmit the acceptance to the serve.

7. The method as recited in claim 1, wherein the transaction initiating terminal is a television set used for displaying shopping information and the encoded image generated by the server.

8. The method as recited in claim 1, where the transaction initiating terminal is a computer or mobile device used by a physical shop to invoice customers on the shop's premises.

9. The method as recited in claim 1, wherein the transaction initiating terminal is a personal computer used by the payer to conduct online shopping at a website of the payee.

10. The method as recited in claim 1, wherein the transaction initiating terminal is a handheld device having an electronic display used by a delivery person to collect payment from the payer at a delivery location.

11. The method as recited in claim 1, wherein the transaction initiating terminal is a mobile device of the payee for conducting person-to-person fund transfer, and the method further comprising:
allowing the payee to enter the offer of the transaction in an application program run on the mobile device of the payee, the application program being programmed to transmit the offer of the transaction to the server.

12. The method as recited in claim 1, wherein the encoded image further encodes at least part of the description of the transaction, the amount of money involved in the transaction, and an identity of the payee.

13. The method as recited in claim 1, wherein the encoded image is a two-dimensional barcode.

14. A method for performing a payment transaction, the method comprising:
receiving at a server an offer of a transaction from a payee, the offer of the transaction including at least a type of the transaction and an amount of money involved in the transaction;
generating a transaction identity in a transaction processing system on the server to identify the transaction, the transaction identity being unique systemwide;
generating at the server an encoded image encoding at least the transaction identity;
transmitting from the server the encoded image to a transaction initiating terminal;
allowing the encoded image or information encoded therein to be passed from the transaction initiating terminal to a mobile device of a payer who has a financial account not preregistered at the server;
receiving an acceptance of the offer at the server from the mobile device of the payer, the acceptance including at least the payer's payment method information and a copy of the encoded image or information encoded therein, wherein the payment method information includes information of the payer's financial account not preregistered at the server and is sufficient to authorize a payment to be made from the payer's financial account;
identifying from the acceptance received from the mobile device the transaction identity and the payer's payment method; and
making a payment according to the identified transaction from the payer financial account to a payee financial account.

15. The method as recited in claim 14, wherein generating the transaction identity in the transaction processing system on the server does not require the payee to have a registered account in the transaction processing system.

16. The method as recited in claim 14, wherein receiving the acceptance at the server from the mobile device of the payer does not require the payer to have a registered account in the transaction processing system.

17. The method as recited in claim 14, wherein allowing the encoded image or information encoded therein to be passed from the transaction initiating terminal to the mobile device of the payer comprises:
displaying the encoded image on the transaction initiating terminal; and
allowing the displayed image to be optically scanned by the mobile device.

18. The method as recited in claim 14, wherein receiving at the server from the mobile device of the payer the acceptance comprises:
receiving the acceptance from an application program run on the mobile device of the payer, the application program being programmed to transmit the acceptance to the server.

19. The method as recited in claim 14, wherein the encoded image is a two-dimensional barcode.

20. A server-based transaction processing system for conducting payments, the transaction processing system comprising at least one server which has a processor, a data storage, and communication means, the transaction processing system being programmed to perform the following acts:
receiving at a server an offer of a transaction from a payee, the offer of the transaction including at least a type of the transaction and an amount of money involved in the transaction;
generating in a transaction processing system on the server a transaction identity to identify the transaction, the transaction identity being unique systemwide among all transactions using the transaction processing system;
generating at the server an encoded image encoding at least the transaction identity;
transmitting from the server the encoded image to a transaction initiating terminal;
allowing the encoded image or information encoded therein to be passed from the transaction initiating terminal to a mobile device of a payer;
receiving an acceptance of the offer at the server from the mobile device of the payer, the acceptance including at least the payer's payment method information and a copy of the encoded image or information encoded therein, wherein the payment method information is sufficient to authorize a payment to be made from a payer financial account;
identifying at the server from the acceptance the transaction identity and the payer's payment method; and
making a payment according to the identified transaction from the payer financial account to a payee financial account.
